(19) United States
(12) Patent Application Publication
(10) Pub. No.: US 2018/0290036 A1
(43) Pub. Date: Oct. 11, 2018

(54) FOOTBALL HAND-OFF TRAINER

(71) Applicant: BENNY WALKER, Celveland, OH (US)

(72) Inventor: BENNY WALKER, Celveland, OH (US)

(21) Appl. No.: 15/482,892

(22) Filed: Apr. 10, 2017

(51) Int. Cl. A63B 69/00; F16M 11/22; F16B 1/00; F16M 11/04; F16M 11/08

(52) U.S. Cl. CPC A63B 69/00; F16M 11/22; F16B 1/00; F16M 11/043; F16M 11/08; A63B 2208/0204; F16M 2200/066; F16M 2200/08; F16B 2001/0035; A63B 2243/007; F16M 11/041

(57) ABSTRACT

A football hand off training apparatus includes a vertical stand, and a rigid bracket affixed to a side of the vertical stand at an upper position and a lower position with a length separated from the vertical stand in between the upper position and the lower position. A clamp releasably attaches to a portion of the length of the bracket. An arm rotatably connects to the clamp and releasably connects to a football and rotates in a horizontal plane.

Priority is claimed to a co-pending design application entitled “Mr. Hand-Off Football Trainer” Ser. No. 29/505,913 filed on Apr. 5, 2016, which is herein incorporated by reference.

### FIELD OF THE INVENTION

The following generally relates to an apparatus that trains players in football running plays and more specifically with a hand-off of a football received by a runner.

### BACKGROUND OF THE INVENTION

In football running plays, a quarterback typically hands off a football to a runner, such as running back, full back, end, receiver and the like. Practice allows players, while running, to receive the football in an area of the upper abdomen and/or lower chest called “the pocket” or “the pouch” without fumbling the football, and to proceed to a position in a line where player blockers have created an expected opening for the runner to gain yardage. A professional football weighs less than a pound.

In order to practice the hand off, at least two persons are involved, one to receive the football as the runner and another to act in the role of the quarterback. In youth training, an adult often functions as an experienced quarterback. However, differences in physical size of the person can affect the mechanics of the hand off.

Additional persons are often involved in repetitive drills to allow for practice by multiple runners. The additional persons typically aid in the recovery and set-up for the person playing the role of the quarterback for the hand off with the football, e.g. obtaining a football for the next runner to receive.

Hand-off practice can also include practicing running to a specific location on the line. For example a runner receives the football while proceeding to an expected opening in the line between two team mates, such as a tackle and a tight end. Motion toward a hand-off begins when the quarterback receives the football from the center, i.e. “the snap”. The runner practices the mechanics of receiving the football while also practicing the mechanics of proceeding to a position on the line, e.g. different directions from a starting position relative to the quarterback.

### SUMMARY OF THE INVENTION

Aspects described herein address the above-referenced problems and others.

The following describes embodiments of an apparatus for practicing a hand-off of a football to a runner which includes an armature that releasably attaches to a football with a minimum force of 20 pounds.

In one aspect, a football hand off training apparatus includes a vertical stand, and a rigid bracket affixed to a side of the vertical stand at an upper position and a lower position with a length separated from the vertical stand in between the upper position and the lower position. A clamp releasably attaches to a portion of the length of the bracket. An arm rotatably connects to the clamp and releasably connects to a football and rotates in a horizontal plane.

In another aspect, a football hand off training apparatus includes a vertical stand, and an arm rotatably connected to the vertical stand and releasbly connected to a football and rotatable around an axis of rotation oblique to the vertical stand.

In another aspect, a football includes an oval shaped ball with a long axis and a short axis, and two couplings, each coupling position at each end of the long axis.

These and other aspects of the invention will be apparent from and elucidated with reference to the embodiment(s) described hereinafter.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 schematically illustrates an embodiment of a football hand-off trainer.

FIG. 2 schematically illustrates another embodiment of the football hand-off trainer.

FIG. 3 schematically illustrates an embodiment in a top view of a clamp with rotatable arm.

FIG. 4 schematically illustrates another embodiment of the football hand-off trainer with a loader.

FIG. 5 schematically illustrates another embodiment of the football hand-off trainer with a loader.

### DETAILED DESCRIPTION OF EMBODIMENTS

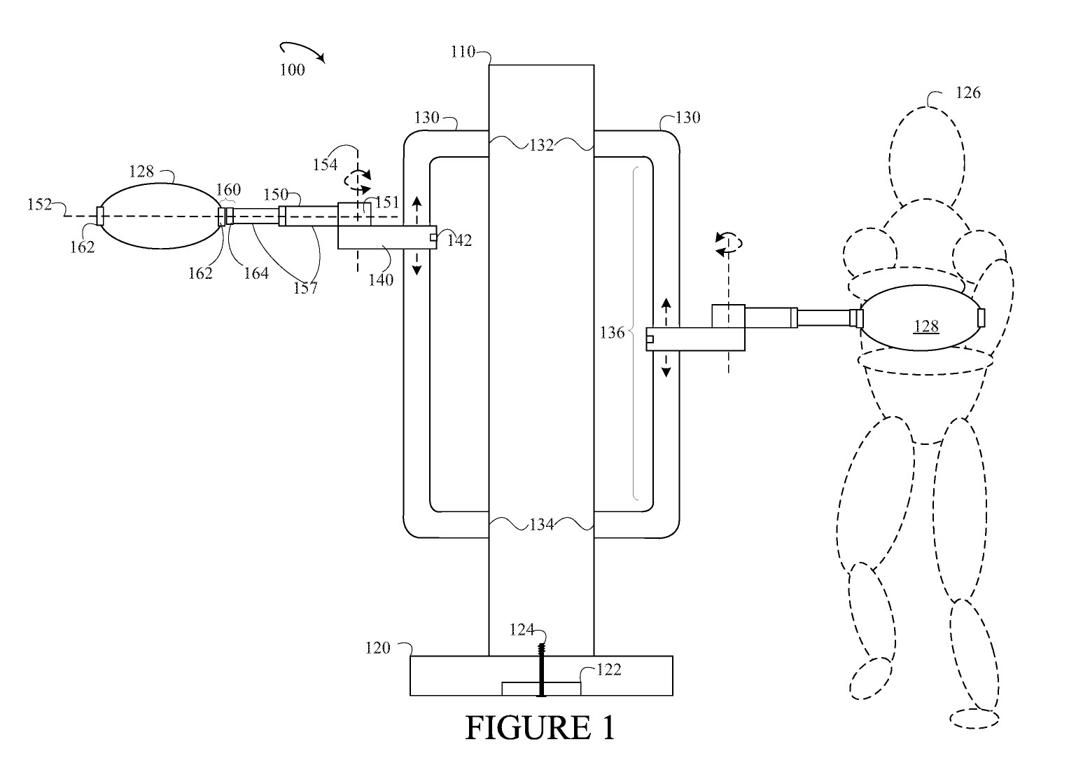

With respect to FIG. 1, an embodiment of a football hand-off trainer 100 is schematically illustrated. The trainer 100 includes a vertical stand 110 connected to a base 120. The vertical stand 110 is formed of a rigid material, such as plastic, wood, metal. The vertical stand 110 can include safety features, such as round edges, padding and the like. In some instances, the vertical stand 110 represents a quarterback. The vertical stand 110 can be cylindrical or rectilinear in shape, such as a wood stand, a polyvinylchloride (PVC) pipe, and the like.

The base 120 includes a heavy material, such as rubber. For example, a rubber mat, such as manufactured for construction barrels, can be affixed to the vertical stand 110 using a metal plate 122 and one or more screws 124 through the rubber mat. The rubber mat can be used with a weight of 22 pounds (lbs.) or more. The rubber mat provides advantage over conventional practice in that the mat is readily available from existing manufacturers, weighted without a fill material, and provides a spring mechanism to keep or return the vertical stand 110 to a vertical position against forces during hand-off, such as the impact from a player 126 receiving a hand-off of the football 128.

A rigid bracket 130 affixes to a side of the vertical stand 110 at an upper position 132 and a lower position 134 with a length 136 separated from the vertical stand 110 and parallel to the vertical stand 110 in between the upper position 132 and the lower position 134. The upper position 132, the lower position 134 and the length 136 can vary according to the variability of running player heights and corresponding positions of “the pocket”. For example, the rigid bracket 130 is positioned relative to the vertical stand 110 including base 120, such that “the pocket” of the various players is at a height within the affixed rigid bracket. The rigid bracket 130 can be cylindrical in shape, such as with PVC pipe or rectilinear in shape, such as squared metal bar. The rigid bracket 130 can include a hollow cavity or include a solid material. In some instances, the rigid bracket 130 serves as a carrying mechanism for transport between practices.

A clamp 140 releasably attaches to a portion of the length 136 of the rigid bracket 130. The clamp 140 in a released configuration is moveable at least the length 136 of the rigid bracket 130. In a clamped configuration the clamp 140 is rigidly attached to the rigid bracket 130. The clamp 140 includes a releasing mechanism 142, such as a nut and bolt, quick release or hinged tapered nut, and the like.

The arm 150 includes a rotatable connection 151 to the clamp 140 and rotates in a horizontal plane 152. In some embodiments an axis of rotation 154 is a vertical axis which includes an overlap between the arm 150 and the clamp 140. The rotatable connection 151 can include a spring, such as a torsion spring, which returns the arm to a set position.

For example, with the arm 150 clamped to the rigid bracket 130 on the side of the vertical stand 110, the spring returns the arm 150 to a predetermined position for repeated practice of a hand-off position. In some instances the arm 150 can be positioned to a set position parallel or oblique to the line through the rigid brackets 130 through the clamp 140.

For example, the arm 150 can be positioned slightly forward, such as closer to a line of scrimmage or slightly backward away from the line of scrimmage for different hand-off positions.

In some embodiments, the arm 150 is releasably connected to the clamp 140. For example, arms 150 of different lengths can be connected to the clamp 140. In some embodiments, the arm 150 includes a telescopic connection 156 of telescopic sections 157. The arm 150 comprises a rigid material, such as PVC, fiberglass, metal, carbon fiber, combinations thereof and the like. The arm 150 extends a length in the horizontal plane 152, and can include a shape, such as a pipe or a rod. In some instances, a length of the arm 150 is configured to represent a distance from “the snap” position to a receiving position relative to a line position for the player receiving the hand-off. For example, a runner begins a starting stance or position relative to the vertical stand 110 and according to “a snap” runs to the hand-off position for the football 128 at an end of the arm 150, while proceeding toward a line position for an expected opening.

The football 128 releasably connects to an end of the arm 150 opposite the connection to the clamp 140. The releasable connection includes a coupling 160 of at least 20 lbs. of force between the football 128 and the arm 150 for release of the football 128 from the arm 150. The football 128 is formed of a compressible material, such as polyurethane with air pockets, NERF®, and the like. The football 128 is shaped similar to an inflatable football, such as an oval, and includes a first portion 162 of the coupling 160 at either end of the long axis of the football 128. The football 128 can include a cavity along the long axis. The arm 150 includes a second portion 164 of the coupling.

The first portion 162 and/or the second portion of the coupling 160 includes a magnet, such as a cylindrical or disk magnet. For example, the first portion 162 includes a disk magnet of at least 20 lbs. pull of force and the second portion 164 includes a magnetic metal, such as iron (Fe), cobalt, nickel, ferromagnetic material, and the like that can magnetically couple to the magnet. In another example, the first portion 162 includes the magnetic metal, and the second portion 164 includes the magnet. In another example, both the first portion 162 and the second portion 164 include magnets, such that the magnetic force exceeds 20 lbs. The magnetic force can include different levels, such as 25 lbs, 30 lbs, 35 lbs, and the like. In some instances, the magnetic force is selected according to experience and/or age of the players.

In some instances, the force of the releasable connection aids the training of the hand-off by simulating the force of hand-off by the quarterback placing the football in “the pocket.” In some instances, the force of the releasable connection aids the training of the hand-off by practicing a grip of the football by the runner in order to detach the football from the arm, which simulates the hand-off.

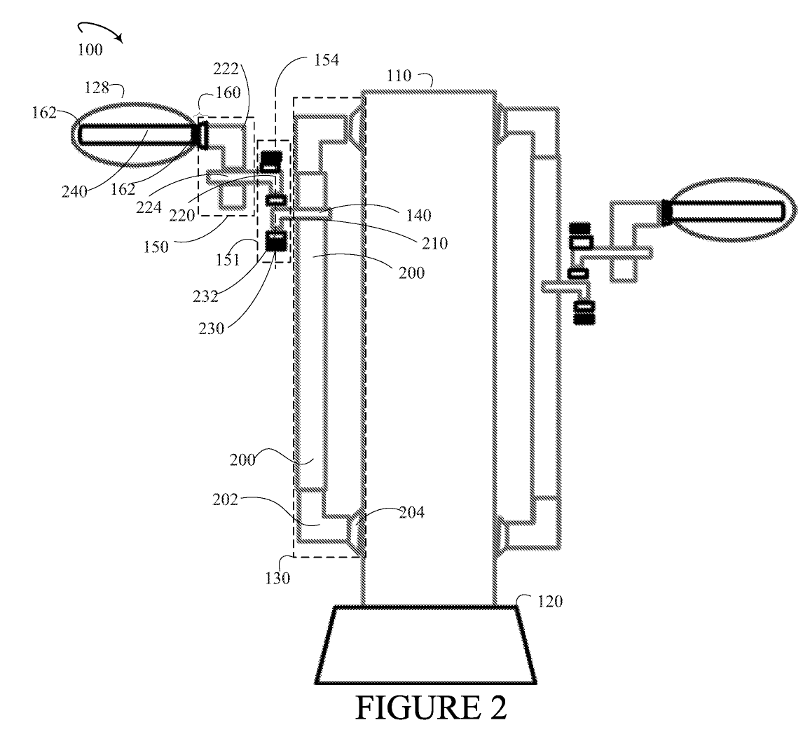

With reference to FIG. 2, another embodiment of the football hand-off trainer 100 is schematically illustrated. The rigid bracket 130 includes impact resistant PVC straight pipe 200, such as 2 inch schedule 40 PVC pipe and corresponding elbows 202. The straight pipe 200 and corresponding elbows 202 can be glued or otherwise joined. The connection of the rigid bracket 130 to the vertical stand 110 includes a flange 204. Different dimensioned PVC pipe are also contemplated.

The rotatable connection 151 includes a configured hinge mechanism shared between the clamp 140 and the arm 150, such as that used in chain link fence gates. The clamp 140 includes a rigid extension 210 that participates in the hinge and the arm 150 also includes a rigid extension 220 that participates in the hinge. The hinge includes a pin that passes vertically through the rigid extension 200 of the clamp 140 and the rigid extension 220 of the arm 150 and rotatably connects the rigid extension 200 of the clamp 140 to the rigid extension 220 of the arm 150. The pin can be secured with nuts 230 or otherwise. Metal washers 232 can be used to spread the pressure over the corresponding portions and reduce wear on the hinge.

The arm 150 includes impact resistant PVC pipe 222, such as 2 inch schedule 40 PVC pipe, with a clamp 224 about the PVC pipe 222 of the arm 150. The clamp 224 includes a rigid connection to the portion of the hinge 220 of the arm 150.

The first portion of the coupling 162, disposed at opposite ends of the long axis of the football 128, connect by a connector 240. The connector 240, such as carriage bolt, narrow PVC tube, and the like, can be metal and/or plastic, and extends along the long axis through the football 128. The first portion of the coupling 162 can be nested within each end of the long axis of the football 128. That is, a portion of the material of the football 128, such as compressible foam, covers the first portion of the coupling 162.

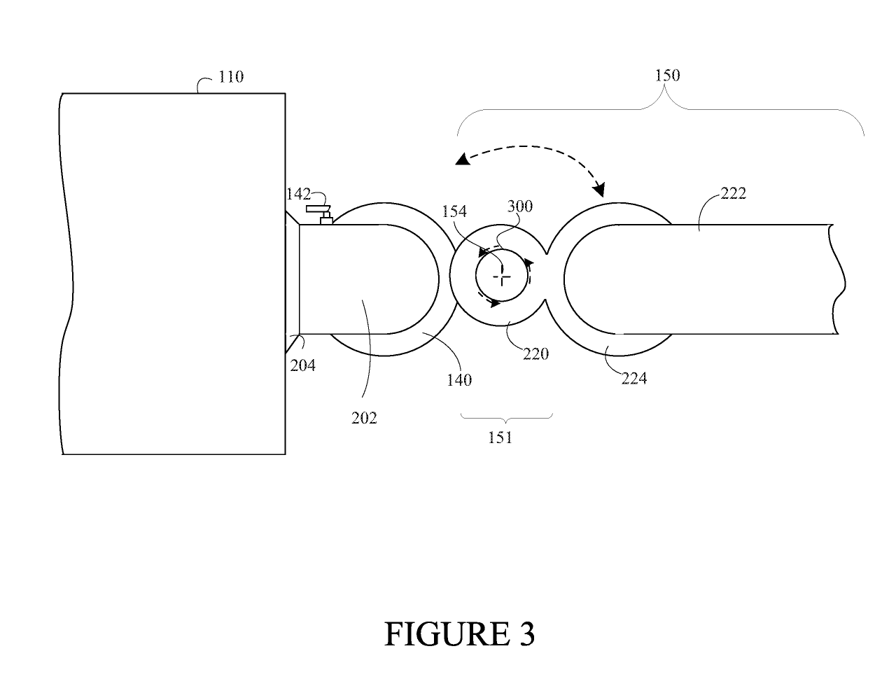

With reference to FIG. 3, an embodiment in a top view of the clamp 140 with the rotatable arm 150 is schematically illustrated. A pin 300 rotatably connects the clamp 140 and by the rigid extension 220, the arm 150. The pin 300 includes the axis of rotation 154.

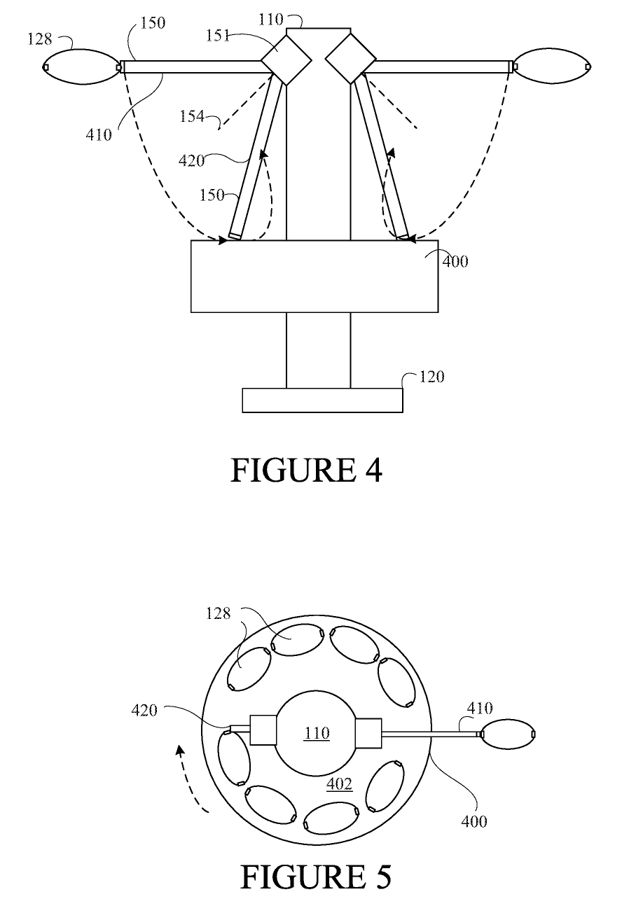

With reference to FIG. 4, another embodiment of the football hand-off trainer 100 with a loader 400 schematically illustrated in a front view, and with reference to FIG. 5 a top view. The loader 400 is positioned with the vertical stand 110 in disposed in a center of the loader 400. The loader 400 is configured with a horizontal surface 402 that rotates about the vertical stand 110.

The loader 400 is loaded with a plurality of footballs 128 positioned on the horizontal surface 402. The horizontal surface 402 can include indentations or protrusions to aid with positioning of the footballs 128. The loader 400 is configured to receive the footballs 128, each in a predetermined position. The positioning of each football can include the long axis of the football 128 aligned along a circle of rotation about the vertical stand 110. In some embodiments, the long axis of the football 128 extends radially from the vertical stand 110. In some embodiments, the long axis of the football 128 extends vertically in parallel with the vertical stand 110.

One or more arms 150 rotatably connect via the rotatable connection 151 to the vertical stand 110. The axis of rotation 154 for each arm 150 is at an angle oblique to the vertical stand 110, such as 45 degrees. A first rotational position 410 of the arm 150 is perpendicular to the vertical stand 110. The first position 410 is the hand-off position. A second position 420 of the arm 150 is substantially parallel to the vertical stand 110. The second position 420 is the load position, which receives or loads a football 128. That is, in the second position 420 the coupling 164 of the arm 150 is in proximity to the coupling 162 of the football 128, which couples or loads a next football 128 to the arm 150 in the second position 420. With the pull force of the coupling not less than 20 pounds and the weight of the football 128 substantially less, the next football 128 couples to the arm 150 in the second position 420.

The rotatable connection 151 is tilted relative to the vertical stand 110 and each arm 150. In some embodiments, each rotatable connection 151 connects to two arms 150. In some embodiments, each rotatable connection 151 connects to three arms 150.

A rotational change of the arms 150 can be synchronized with a rotational change of the loader 400. For example, as one arm 150 moves according to force from the player de-coupling the football 128 from the arm 150, another arm with a loaded football is rotationally advanced to the first position 410, and one arm 150 moves to the second position 420 for loading. With each rotational positioning of one arm 150 in the second position 420, a next football 128 loaded in the loader 400 is advanced to position the first portion of the coupling 162 of the next football 128 in proximity of the second portion of the coupling 164 of one arm 150 advanced to the loading or second position 420. The synchronized advancement of the horizontal surface 402 of the loader 420 can be mechanical and/or with a motor assist, such as an electrical motor (not shown). In some embodiments, a remote control (not shown) can be used to advance the arm 150 to either of the first position 410 or the second position 420.

The invention has been described with reference to the preferred embodiments. Modifications and alterations may occur to others upon reading and understanding the preceding detailed description. It is intended that the invention is constructed as including all such modifications and alterations insofar as they come within the scope of the appended claims or the equivalents thereof. The word “comprising” does not exclude other elements or steps, and the indefinite article “a” or “an” does not exclude a plurality.

1. A football hand off training apparatus, comprising:
a vertical stand;
two rigid brackets, each rigid bracket affixed to a side of the vertical stand at an upper position and a lower position with a length separated from and parallel to the vertical stand in between the upper position and the lower position, and the two rigid brackets attached to opposing sides of the vertical stand;
two clamps, each clamp releasably attached to a portion of the length of one of the two rigid brackets, wherein each of the two clamps move independently of the other clamp along the length of a corresponding rigid bracket of the two rigid brackets; and
two arms, each arm offset from the vertical stand, rotatably connected to a corresponding clamp of the two clamps, releasably connected to a football, and rotatable in a horizontal plane.

2. The apparatus of claim 1, wherein each arm includes a magnetic connection that releasably connects to an end along a long axis of the football and holds the football with the long axis perpendicular to the vertical stand.

3. The apparatus of claim 2, wherein each arm includes a non-electrical magnet with a pull force of at least 20 pounds.

4. The apparatus of claim 1, further including:
a rubber base affixed to the vertical stand.

5. The apparatus of claim 1, wherein each bracket includes a uniform surface along the length the upper position and the lower position; and wherein each clamp is vertically positionable at any position along the uniform surface of the length of one of the two brackets and releasably attached by friction to the uniform surface along the length of the corresponding bracket.

6. The apparatus of claim 1, wherein each clamp comprises a spring coupled between the corresponding clamp and a corresponding arm of the two arms to resist rotational movement of the corresponding arm about the corresponding clamp.

7. The apparatus of claim 1, wherein each clamp comprises a rotatable pin connection to a corresponding arm of the two arms.

8. The apparatus of claim 1, wherein each arm is adjustable in length with telescoping sections.

9. A football hand off training apparatus, comprising:
a vertical stand; and
an arm rotatably connected to the vertical stand and releasbly connected to a football by a magnetic connection and rotatable around an axis of rotation that is oblique to the vertical stand, wherein the arm in a first rotational position is perpendicular to the vertical stand and configured to magnetically connect to and hold an end of a first football with a long axis of the football perpendicular to the vertical stand, and in a second rotational position is substantially parallel to the vertical stand and configured to magnetically connect with a second football.

10. (canceled)

11. The apparatus of claim 9, further comprising:
a plurality of arms, each rotatably connected to the vertical stand and each rotating about an axis of rotation, and each of the plurality arms connected to the vertical stand on opposing sides of the vertical stand.

12. The apparatus of claim 9, further including:
a rotatable horizontal surface centered around the vertical stand and configured to hold a plurality of footballs and to rotate synchronously with rotation of the arm, and in the second rotational position the rotatable horizontal surface synchronously positions the second football to magnetically couple with the arm.

13. The apparatus of claim 12, wherein the rotatable horizontal surface is configured for a distance of synchronous rotational movement of at least a length according to a size of a next football of the plurality of footballs to position the next football to couple with the arm in the second rotational position, and the synchronous rotational movement of the rotatable horizontal surface corresponds with each movement from the first position to the second position of the arm.

14. The apparatus of claim 9, wherein the arm includes a magnetic connection that releasably connects to an end of a long axis of the football and holds the football with the long axis perpendicular to the vertical stand in the first position.

15. The apparatus of claim 14, wherein the arm includes a non-electrical magnet with a pull force of at least 20 pounds.

16. A football, comprising:
an oval shaped ball with a long axis and a short axis; and
two couplings, each coupling positioned at each end of the long axis, wherein each coupling is configured to magnetically hold the oval shaped ball at each end of the long axis in a coupled position with the long axis of the oval shaped ball perpendicular to gravitational forces.

17. The football of claim 16, wherein the football comprises a compressible foam about a cavity centered along the long axis.

18. The football of claim 17, wherein the football further comprises:
a connector between the two couplings that passes along the long axis of the football, each end of the connector each affixed to one of the two couplings.

19. The football of claim 16, wherein each coupling includes a non-electrical magnet with a pull force of at least 20 pounds.

20. The football of claim 16, wherein each coupling comprises iron (Fe).
